(19) United States
(12) Patent Application Publication
(10) Pub. No.: US 2009/0048944 A1
(43) Pub. Date: Feb. 19, 2009

(54) SYSTEM AND METHOD FOR ESTABLISHING AN AUTO REPAIR NETWORK

(75) Inventor: Bryce Eagle, Folsom, CA (US)

Correspondence Address: JOHN P. O'BANION;O'BANION & RITCHEY LLP, 400 CAPITOL MALL SUITE 1550, SACRAMENTO, CA, 95814, US

(73) Assignee: PAY MY DEDUCTIBLE, INC., Folsom, CA (US)

(21) Appl. No.: 12/189,309

(22) Filed: Aug. 11, 2008

Related U.S. Application Data
(60) Provisional application No. 60/955,005, filed on Aug. 9, 2007.

(51) Int. Cl. G06Q 30/00

(52) U.S. Cl. 705/27; 705/1

(57) ABSTRACT

An auto repair network is shown that is configured to follow specific standards of repair and guarantee work for at least a portion of the life of the vehicle, along with deductible assistance to the consumer. Consumers have access to the network of repair shops that have agreed to license and follow specific standards via a web site to select one or more licensing repair facilities that are convenient to them.

### CROSS-REFERENCE TO RELATED APPLICATIONS

This application claims priority from U.S. provisional application Ser. No. 60/955,005 filed on Aug. 9, 2007, herein incorporated by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to systems and methods for establishing an auto body repair network, and more particularly to establishing an auto body repair network that has agreed to repair vehicles to a set of repair standards.

2. Description of Related Art

The general consumer faces a number of problems when dealing with auto body repair.

First, consumers typically pay the high cost of insurance deductibles to their insurance companies when an accident claim is made. Additionally, it is often difficult for consumers to find high quality shops without them conducting an extensive search.

In addition, there can be a conflict of interest and a negative relationship between the consumer, the auto body repair shop and the automobile insurance companies through the insurance companies' direct repair programs (DRP).

Furthermore, insurance DRP programs tend to promote repair process shortcuts and/or the use of imitation or substandard parts on insured vehicles. In order for auto body repair shops to receive referral work from insurance companies, they require the auto body shops to qualify for their Direct Repair Program (DRP). Typically, these programs require the auto body shops to discount their billable rates significantly. Additionally, the shops must also agree to use imitation or sub-quality parts—and limit repair procedures as stipulated by the insurance company. Both of these requirements negatively affect the repair shop's reputation and financial status.

Accordingly, an object of the present invention is to method and system for allowing consumers access to a network of repair shops that have agreed to license and follow specific standards when repairing an automobile for a program member.

### BRIEF SUMMARY OF THE INVENTION

The systems and methods of the present invention provide customer access to a collision repair network configured to license and follow specific standards of repair and guarantee their work for at least a portion of the life of the vehicle, along with providing deductible assistance to the consumer. The present invention provides consumer advocacy and education, targeted media and marketing services, access to certified genuine OEM recycled parts, and a niche third party salvage vehicle disposal service, among other benefits. The system and methods of the present invention utilize a website (e.g. PayMyDeductible.com) along with a crash services repair network to protect a vehicle owner's best interests in case of an accident or insurance claim. The model of the present invention cross-markets a unique supplemental deductible payment methods with a consumer advocacy claims service, directly to consumers and through established voluntary employee benefit companies.

As an additional benefit of the present invention, members will receive a substantial portion (up to 100%) of their insurance deductible in cases where they owe a deductible for a claim.

A company or organization is set up (hereinafter “administrative entity”) and establishes, organizes and maintains a network of repair shops that have agreed to repair vehicles for customer members to a set of preset repair standards. The preset repair standards of the present invention are also configured to support existing Bureau of Automotive Repair laws that dictate that vehicles be repaired to pre-collision condition. The system benefits both consumers and insurance companies by preserving the value and safety of the vehicle while minimizing the potential for diminished value claims against insurers. The system further benefits repair shops by increasing the number of potential repair leads they receive that are not restricted by individual insurance company DRP contracts.

Repair shops may license the preset repair standards and web-based technology platform for each repair job completed using the standards/platform. The repair standards, licensing model, and license agreement/fees may be distributed over the internet—and may be based on each repair initiated for a member. Repair shops will license and agree to the established standards/warranty for each customer/repair. The repair shops may be pre-screened and/or pre-listed in the shop network—or they may qualify and sign up in the network if a member demands the established standards while seeking out their services.

The repair shops also benefit by increasing the number of repair leads they receive that are not restricted by individual insurance company DRP contracts. The integrated technology platform of the present invention assigns a job number to identify the customer, the claim, and their insurance company. The platform also tracks the individual DRP's for each shop and is designed to route PMD members to the nearest non-DRP first—but is not dependent on this feature to operate.

In addition to the high value repair leads generated directly by the crash services repair network, leads may also be attracted via the website and other marketing proposing to pay at least a portion of the automobile driver's insurance deductible in cases where they actually owe a deductible for an accident or damage claim.

Members of the crash services repair network will benefit by having ready access to a network of independent repair shops that have only their best interests in mind. This benefit is generally available for any repair claim—regardless of whether the loss is insured or a deductible is owed. This benefit helps consumers and repair shops in all cases (1st and/or 3rd party claims). In addition, consumers will receive detailed educational information regarding the insurance repair industries, as well as specific guidance designed to protect them from certain insurance repair programs, practices, tactics, and procedures. Claims notification and access to the shop network will be seamless via toll free telephone and the web-based platform. Legal service referrals or direct access to a pre-paid attorney network may be additional modules of the platform to help consumers and repair shops negotiate their claim interests.

The website (e.g. PayMyDeductible.com) members will preferably also receive a substantial portion (up to 100%) of their insurance deductible in cases where they owe a deductible for a claim. In this regard, the website may act to support the supplemental deductible assistance provided to the consumer. In addition, both the supplemental deductible assistance system and the crash services system may be marketed and distributed through non-web based channels, such as voluntary employee benefits programs, corporate marketing partners, and direct mail or other traditional marketing methods.

The systems and methods of the present invention also facilitate educating the public about insurance and repair laws—and how the conflicts of interest that exist between them, their insurance company, and the repair shop can result in repair process short-cuts and/or sub-standard repairs. This may be achieved through consumer advertising that give examples and explains the details of how sub-standard parts and repairs can potentially affect the safety and future value of their vehicle. The methods of the present invention help clarify and reinforce their rights as insureds and consumers—and help guide them to protect those rights in case of an accident or damage claim.

In case of a total loss, a conditional sales contract may be in place that gives the administrative entity (or its agent) the right of first refusal to buy their customer's retained salvage vehicle for resale. The administrative entity may also offer members a consignment service for uninsured motorist events and/or 3rd party payoff liquidations.

The system and methods of the present invention also provide for a “green” repair option at sign-up. The green repair option allows customers to request and/or authorize the use of certified genuine OEM recycled parts (when available) in the repair of their vehicle. This option may cost the consumer more or it may be offered with a discount, and the administrative entity may donate a portion of the sign-up fee to an environmentally aware charity—and provide a tax deduction certificate to the customer. In addition to the potential for extra membership fees, the administrative entity may benefit by leveraging the consumer's awareness of the importance of recycling and protecting the environment. This additional value channel also allows the administrative entity to add certified auto parts recyclers to its network and platform. The entity may develop and maintain a set of quality control standards and/or inspection processes for recycled auto parts. These quality standards and/or inspection processes may be licensed to network auto parts recyclers. This creates more revenue opportunities for the administrative entity through licensing of the recycled parts standards, the sourcing of recycled parts for customer members—and by creating distribution synergies between the established network repair shops and the certified parts recyclers. There may also be tax breaks and pollution credits available to the administrative entity as a result of integrating this strategy. The green repair option may also be offered with the deductible payment service ala-carte for a reduced annual membership fee. This could lead to more early sign-ups and faster product to market.

The administrative entity may also collect a large volume of vehicle specific customer information which will be monetized by providing high-value targeted sales leads and advertising opportunities to partner and customer companies

An aspect of the invention is a method and system for allowing consumers to access a network of repair shops that have agreed to license and follow specific standards when repairing an automobile for a program member—and have agreed to guaranty their repair work for at least a portion of the life of the vehicle. The consumer will be able to call and/or go to a web site in accordance with the present invention to select one or more licensing repair facilities that are convenient to them. The consumer will then deliver the vehicle to their shop of choice for the repairs. This primary service/benefit is available to the customer/member in all repair cases regardless of whether the loss is insured or a deductible is involved.

Another aspect of the present invention is a platform allowing the consumer to sell the damaged vehicle to the company or its designated agent via a conditional sales agreement. The company or its designated agent will then have the ability to negotiate the salvage value with the consumer's insurance company. The company will be able to insert into the conditional sales contract limitations or conditions that would allow the company to return the damaged vehicle to the customer in the event one or more of the enumerated conditions are not fulfilled during the negotiation process with its customer's insurance company.

Another aspect is method for establishing a repair network, comprising establishing a list of repair standards and a network of repair shops agreeing to license and adhere to the repair standards, providing one of the repair shops with a consumer having a vehicle needing repair; and collecting a licensing fee from the repair shop prior to repair of the vehicle.

In a preferred embodiment of the current aspect, the repair shop comprises an auto body repair shop, and the repair comprises auto body repair for a vehicle collision.

In another embodiment, the method includes establishing a website having data including the repair standards and network of repair shops, and graphically displaying the repair standards and network of repair shops for viewing by the consumer.

The consumer may register for access to the repair network through the website, and an administrative entity may collect a fee for the consumer registration. Data from the consumer may be inputted from a graphic interface on said website and compiled into a consumer list. Qualified sales leads may be generated from the consumer data.

In another embodiment, the method further includes calculating a payout to the consumer based on the data, and paying the payout to the consumer upon repair of the vehicle within the network using the repair standards. The payout may be a function of the consumer's membership fee, cost of the auto repair, an insurance deductible of the consumer.

In yet another embodiment, the method further includes establishing a network of auto recyclers having certified OEM parts, wherein the network of repair shop agrees to use the OEM parts from one or more of the auto recyclers in repairing the vehicle.

Another aspect is a method for establishing a repair network, comprising establishing list of repair standards and a network of repair shops to adhere to the repair standards, inputting vehicle repair data from a consumer, calculating a payout to the consumer based on the data, and paying the payout to the consumer upon repair of the vehicle within the network using the repair standards. A licensing fee may also be collected from the repair shop prior to repair of the vehicle.

Another aspect is a method for providing repair of a vehicle, comprising establishing an administrative entity, a list of repair standards, and a network of repair shops agreeing to adhere to the repair standards. The method further includes providing one of the repair shops with a consumer having a vehicle needing repair, wherein the consumer is one of a network of consumers registered with the administrative entity. A platform is provided for the network of repair shops and network of consumers to interface with the entity. A licensing fee is collected from the repair shop for the platform, wherein the licensing fee results from a transactional license between the administrative entity and the repair shop prior to repair the vehicle.

In one embodiment, the licensing fee and transactional license are on a per-repair basis.

In another embodiment, the method further includes establishing a network of auto recyclers having certified OEM parts, wherein the network of repair shop agrees to use the OEM parts from one or more of the auto recyclers in repairing the vehicle. A website may be provided that is configured to display a list of repair shops based on location with respect to the consumer. The website may also be configured to automatically set a repair appointment for the consumer at a selected repair shop.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is flow diagram for a system and method for providing auto repair services in accordance with the present invention.

FIG. 2 is a flow diagram for illustrating revenue flow for the auto repair services platform of FIG. 1.

FIG. 3 illustrates a revenue channels for the system and methods of the present invention.

FIG. 4 illustrates method and system for providing auto repair services over a website in accordance with the present invention.

FIG. 5 illustrates a method for facilitating a collision repair within a network of repair facilities.

FIG. 6 illustrates a flowchart for calculating deductible payment assistance in accordance with the present invention.

FIG. 7 illustrates a green option for providing recycled parts for repair in accordance with the present invention.

### DETAILED DESCRIPTION OF THE INVENTION

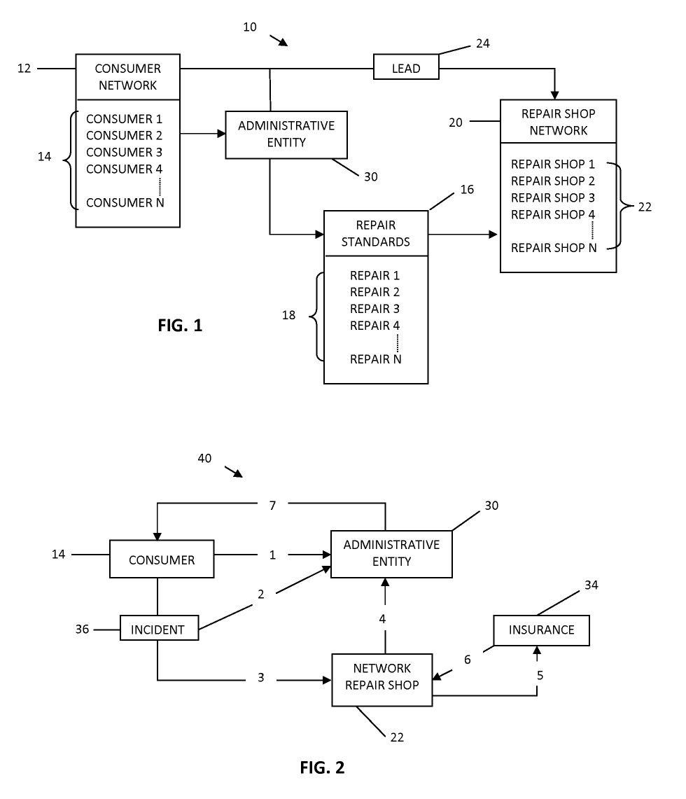

Referring more specifically to the drawings, for illustrative purposes the present invention is embodied in the apparatus generally shown in FIG. 1 through FIG. 7. It will be appreciated that the apparatus may vary as to configuration and as to details of the parts, and that the method may vary as to the specific steps and sequence, without departing from the basic concepts as disclosed herein.

FIG. 1 illustrates a system 10 for providing a network auto repair facilities in accordance with the present invention. Although the examples below will primarily be directed to auto-body collision repair, it is appreciated that the system and methods may be applied to any type of repair. As shown in FIG. 1, an administrative entity (AE) 30 is set up to provide different levels of auto repair service options that may be distributed through multiple channels.

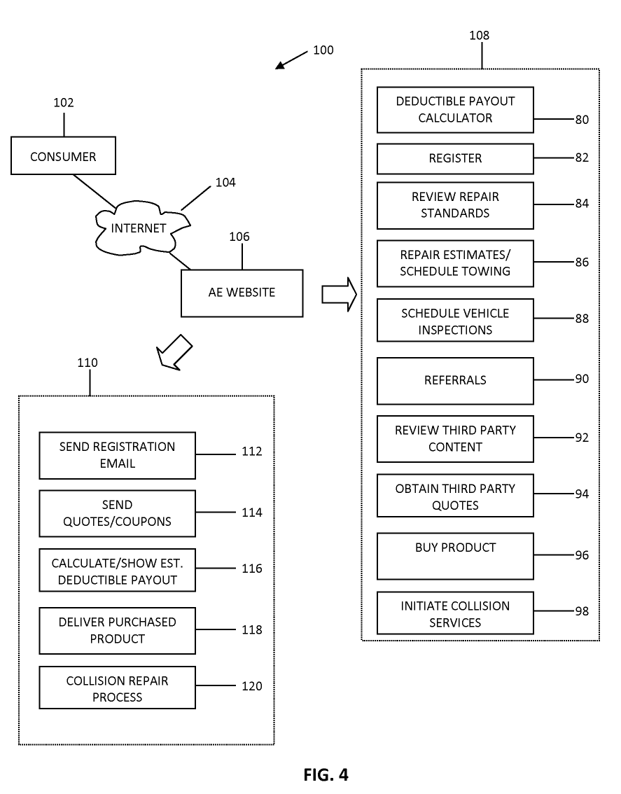

The primary service provided to consumers is the generation and/or maintenance of a preset list 16 of individual repair standards 18, in addition to a network 20 of individual repair facilities or shops 22 and technology platform that facilitates communication between AE 30, consumer 14, and repair shop 22. The technology platform may comprise the AE website shown in FIG. 4, and/or other interface and communication means between the repair shop network 20 and AE 30.

When an individual consumer finds themselves in need of a repair, the AE makes available to them the list of network shops 20. The consumer may view a smaller subset of individual shops 22 that are located near the consumer, and/or that have some other identifiable characteristic such as specializing in a type of repair (e.g. windshield, body repair, frame repair, finishing, etc.) or the make or model of the consumer's vehicle. Thus, the repair shop obtains a lead 24 through the AE 30 that they may otherwise not have had. As will be described in further detail below, the AE 30 is preferably compensated a licensing fee (preferably on a per-transaction basis) in exchange for the repair standards and technology platform that generate the lead 24.

The AE 30 preferably attracts and acquires a consumer network 12 that comprises a high number of individual consumers 14, primarily through the value provided by allowing the consumer to have their vehicle repaired through a network of repair shops following a set of guidelines (preset repair standards 16) that protect their interest, rather than through shops that agree to guidelines that protect the consumer's insurance company's interest. Within the typical DRP relationship between insurance companies, the repair shops must comply with parts approval from the insurance company, limitations on covered repair procedures, and discounted billable rates. In exchange for a repair shop complying with these requirements, they generally receive repair referral leads from the insurance company. Typically, these programs require the auto body shops to discount their billable rates significantly and must also use imitation or sub-quality parts if stipulated by the insurance company. In many cases, the DRP relationship may negatively affect the repair shop's reputation and financial status. However, shops unwilling to compromise their rates, parts, or procedures, may be forced to downsize or close if this gap is not effectively addressed.

Thus, in the system 10 illustrated in FIG. 1, repair shops 22 will enjoy the freedom to provide services according to the consumer's demands without having to discount their billable rates or lose business. Correspondingly, the consumer 14 receives repair work and parts that are par with the highest reasonable standards.

The repair standards may comprise one or more of the following requirements: 1) structural and cosmetic repairs be performed to the vehicle manufacturer's specifications, 2) repairs be performed to support existing insurance repair laws and Bureau of Automotive Repair laws by returning the vehicle to as close to pre-collision condition as possible, 3) repairs must be guaranteed for the life of the vehicle (collision), or designated portion thereof; 4) repairs be performed to standards similar to or comprising the industry-accepted Uniform Procedures for Collision Repair (UPCR), and 4) any other applicable standard available in the art.

Repair shops 22 in the established network 20 will not be required to reduce their billable rates, and will be able to utilize any parts or procedures they determine necessary to repair vehicles properly. In addition to the freedom the network provides, the repair shops 22 will receive a consistent amount of Non-DRP repair leads. The net cost of the AE license fees to the repair shops is substantially less than their current net lead cost under the DRP programs.

An additional incentive to promote consumers to join or register in network 12 is a deductible payment assistance program that pays all or a portion of a consumer's 14 automotive insurance deductible when a claim is made. This service is generally provided when the consumer 14 enlists and pre-registers with the AE 30 for a nominal annual fee.

When a consumer 14 registers into network 12, they will generally be directed to provide personal information including insured vehicle data, household, and financial information. This high-value, targeted data may be converted into additional revenue for the AE 30 through licensing qualified sales leads and selling targeted advertising lists.

The consumer 14 may opt for both inclusion in the auto repair network services, and deductible payback assistance. These services may be packaged and sold as voluntary employee benefits (similar to Aflac or Pre-Paid Legal services), which may be further re-sold with a revenue share through a network of existing employee benefit resellers. In addition, the methods and access to the AE 30 repair network 20 & technology platform could also be licensed to branded, top-tier supplemental insurance carriers.

As consumers 14 are registered —either in person, call center (e.g. 1-800 number), or on the AE website illustrated in FIG. 4 and described in further detail below, the AE may collect vehicle, financial and personal information which can be used to sell targeted qualified sales leads, customer sales lists, and online ad units to customer companies, such as Visa, BMW, Microsoft, etc.

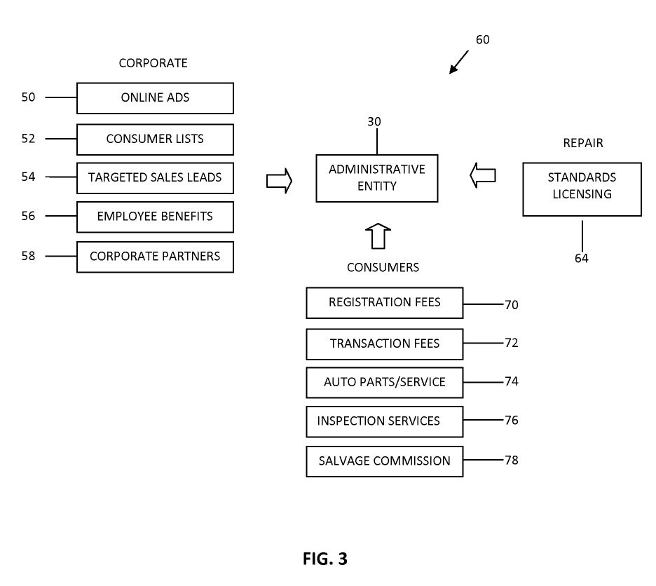

FIG. 2 is a flow diagram for illustrating revenue flow 40 for a transaction under the auto repair standards and network of FIG. 1. The consumer 14 will typically register with the AE 30, and pay an annual membership fee (detailed as arrow 1). This membership fee may vary depending on the level of services desired by the consumer 14.

When a collision or incident 36 occurs, the consumer may pay a nominal transaction fee to the AE 30 (detailed as arrow 1), so that they may have access to the repair network 20. The consumer 14 brings their car in to their selected repair shop 22, and pays the shop 22 the insurance deductible (if any) owed based on their insurance policy (detailed as arrow 3).

The repair shop 22 then pays a licensing fee to the AE 30 for access to the repair standards 18 and technology platform provided by the AE 30. The repair shop 22 is then required to adhere to the strict set of defined repair standards 18 and procedures when repairing the vehicle and will provide customers 14 with their warranty (preferably life of the vehicle for collision repair) and a comprehensive checklist of these standards before and after each repairjob.

The repair shop 22 then bills the insurance company 34 (minus the collected deductible amount) (detailed as arrow 5) and received reimbursement for the costs from the insurance company (detailed as arrow 6). If the consumer 14 opted into the deductible assistance program, the AE issues payment of all or a portion of the deductible amount to the consumer 14 (detailed as arrow 7).

FIG. 3 illustrates a flow diagram 60 of the revenue channels for the system and methods of the present invention. Generally, the AE 30 generates revenue from three sources: repair shops, consumers, and third party corporate partners.

Possibly the largest revenue source will be generated from the licensing of the repair standards 16 and technology platform to the network repair shops 22. Preferably, the AE 30 will charge the participating repair shops 16 a nominal license fee 64 (e.g. 5% to 8% of repair bill) for each repair job completed using the repair standards 16 and technology. This fee may primarily supplement the AE's cost structure for deductible payouts. These license fees are significantly lower than the net lead cost to the shops through an insurance company's DRP. As most of this revenue covers the direct costs of the consumer's deductible payout (if any), the annual fees and other revenue channels are open to produce the bulk of the profits.

On the consumer end, registration fees 70 will be generated by the AE 30 based on the product mix and/or level of service chosen by the consumer 14 (e.g. a $29-$59 annual membership fee per user). For example, if a consumer 14 only opts for membership in the collision repair network (e.g. no deductible assistance) they may pay the lowest annual fee amount. On other hand if the consumer opts for full (e.g. 100% deductible reimbursement) they may pay the largest annual fee amount. Consumers 14 may also pay intermediate amounts based on deductible amount, total repair costs, other program options, etc. Consumers 14 are not required to pre-register in order to take advantage of network services. For example, unregistered users will have the opportunity to register online, by phone, or at the repair shop after an accident, and the AE may pay a portion of their deductible. However, these new customers will receive a lower percentage payment on their deductible than customers who are pre-registered and/or pre-paid.

If a user has a collision repaired through the network, a transaction fee 72 may also be charged. The transaction fees alleviate processing costs, and act to compensate for some consumers who may be accident prone.

Consumers will also have the options to shop for parts, accessories, and other products and services 74 on the AE website 106 (see FIG. 4). The AE 30 may partner with online distributors to sell automotive parts and accessories such as hard parts, car mats, stereos, seat covers, sun visors, car cleaning supplies, etc. The AE may collect a percentage of sales completed on the site. Some inventory may be retained by the AE, but the majority of the products will be shipped directly from the supplier to reduce costs.

Revenue may also be derived from inspection services 76 requested by the consumer 14. For example, post-repair inspection services may be performed for customers seeking to confirm the quality, accuracy, and completeness of repairs performed by non-network repair shops. Other revenue opportunities exist for the AE 30 by licensing the repair standards 16 to provide pre-purchase vehicle inspections and certifications.

Revenue may also be generated from salvage retention buyback 78, i.e. the sale of owner-retained total-loss salvaged vehicles: The AE 30 may secure the right to the salvaged vehicle and pay the consumer 14 the negotiated salvage value from the insurance company. The AE 30 may retain a first right refusal by having a conditional sales contract that allows the AE 30 to purchase these vehicles if certain conditions are met (e.g. total loss, and satisfactory salvage value, etc). If a totaled vehicle is purchased by the AE, it may be re-sold to auto recyclers at a profit—or the AE may list it on the website and take a commission when sold.

On a corporate level, the AE 30 may be able to offer multiple levels of advertising space 50 to its clients via the website 106. The website 106 will have heavily traffic from clients, insurance firms, repair shops, and market research firms, with dynamic advertising readily available to those who wish to reach their intended audience. Various ad unit forms will be on the site. Micro-site opportunities will also be available to advertisers.

The registration process for becoming a member or certified repair shop will allow the AE 30 to gather a vast amount of opt-in consumer information (consumer lists 52) that can be shared with partners or sold to major national marketing firms. The comprehensive and targeted marketing information that is collected may allow the AE 30 to sell customer lists in the upper price range for such information. Exemplary companies that may purchase these lists may comprise Experian Information Systems, auto, computer, retail, and insurance companies.

Revenue may also be generated through targeted sales leads 54. Consumers 14 may use the website 106 to search for the insurance rates, look for the nearest oil change business and make an appointment, credit card, auto manufacturers, or download coupons. Registered users will also be encouraged to receive sales quotes from companies such as Honda, Capital One, Country Wide Mortgage, Progressive Auto Insurance, etc.

As more companies sign up with the AE 30 to receive targeted qualified sales leads, these companies will be segmented by industry such as credit card, automotive, insurance, finance, warranty, etc. When the user inserts their contact and financial information, these leads may be passed along to the appropriate partner company for a fee. Cross-promotional opportunities with these partner companies may also be leveraged in order to drive more traffic to the AE 30 and increase user registrations. Marketing partners may offer the AE 30 services as an inexpensive incentive to attract more customers to their own products and services. Examples include major car & truck manufacturers, credit card companies, and vehicle finance companies such as GMAC.

Employee benefits companies 56 may also provide for revenues to the AE. The collision repair network and/or deductible assistance program may be packaged and sold as voluntary employee benefits (similar to Aflac or Pre-Paid Legal services), which may be further re-sold with a revenue share through a network of existing employee benefit resellers.

Finally, revenue from corporate marketing partnerships 58 may allow companies to offer the collision repair network and/or deductable assistance program and inexpensively attract more customers for their own products and services. Such industries may include: banks and credit unions that provide vehicle financing, vehicle manufacturers, auto dealerships, credit card companies, national auto parts and repair chains, auto repair and body shops, independent insurance agents, and extended warranty companies.

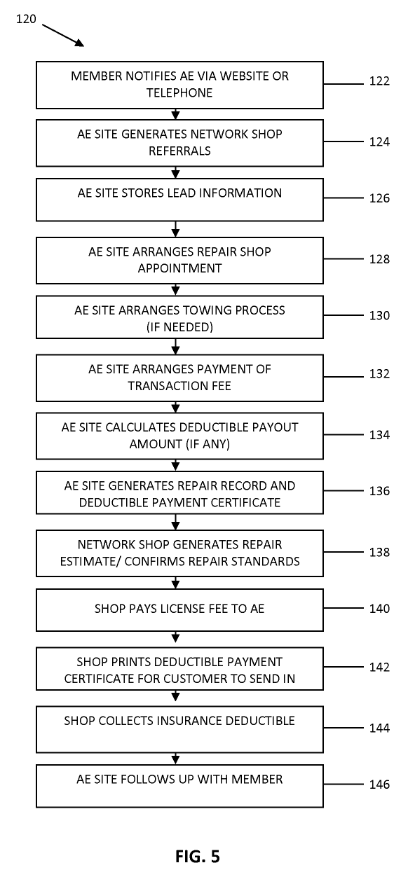

FIG. 4 illustrates method and system 100 for providing auto repair services over a website 106 (e.g. paymydeductible.com) in accordance with the present invention. The AE website may serve as the main communication conduit (e.g. over Internet 104) between consumers 102, network repair shops 22, advertisers, and marketing firms. The primary objective of the website 106 is to function as a platform for carrying out the transaction process to facilitate a repair within the network as shown in method 120 of FIG. 5, e.g. facilitate the payment of deductibles, registration, and general communication between the AE 30, its' network of repair shops, and its' registered customers. It is the platform where members 14 will locate repair shops 22 within the network 20, take advantage of reduced deductibles, track progress, etc.

The website 106 will be the main point of contact for consumers 14. However, consumers 14 may interface with the AE directly through phone or other means. When users arrive on the website 106, the process and benefits of the system will be communicated clearly through text, graphics and interactive demo. The aim of the website 106 is to provide a sense of security for the user to know that their deductible will be covered if they get into an accident (if they sign up for that service), and that their vehicle will be repaired to standards designed to restore their vehicle to pre-collision condition, and that they will have an advocate network looking out for their best interests.

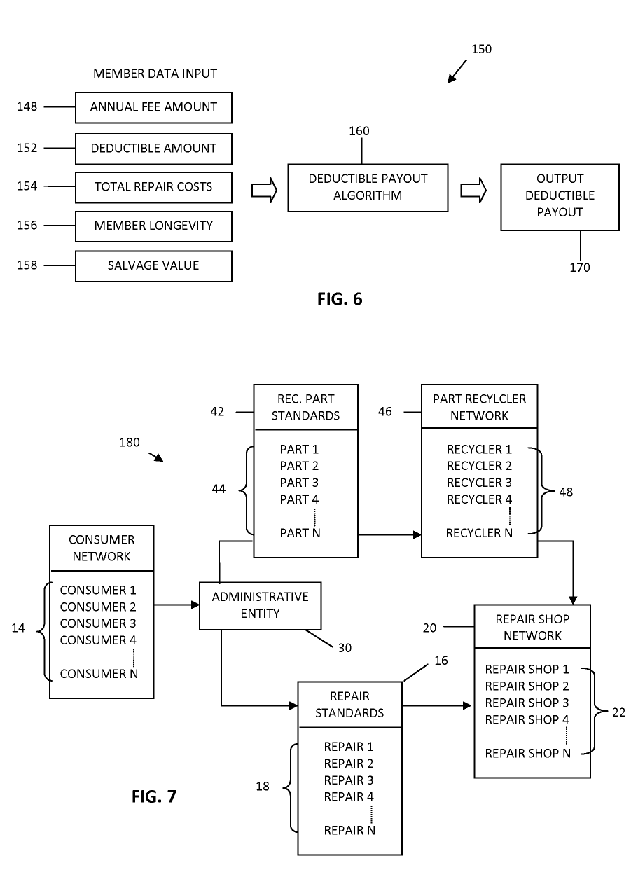

When consumers 14 arrive at the AE website 106, a number of different user features or modules 108 will be available to them. For example they can use the payout calculator (see FIG. 6) to determine a deductible payout amount 80 according to the level of service they have chosen. Users will be encouraged to pre-register 82 with the AE before an accident claim is made. Pre-registration and/or paid registration will generally return the highest levels of deductible reimbursement and other services. However, users will be able to register after the accident and still receive some benefits.

The registration form fields will most likely include:
i. Name (Last Name, First Name)
ii. Credit Card Information
iii. Contact Information (E-mail, Address, Phone)
iv. Information on their cars (Year, Make, and Model, Options, Etc)
v. Insurance company and policy details (e.g. deductible, etc.)
vi. Information on other insured properties (home, marine, motorcycle, etc.)
vii. May include one or more market research questions

When registering, the user will select a service level (e.g. annual payment), and service options available to them (e.g. green option, etc.)

Before or after registration, the user will be able to view the repair standards, procedures and warranties 84, and/or get a list of participating repair shops nearest them (this could be in the form of a locator that pulls up the shops nearest to them by zip code, address, etc.). Users may also be able to search participating repair shops by specialty.

One aspect of the site content of the site (and other advertising) will be the focus on educating users about the benefits of using the network 20 of approved repair shops and the repair standards 16 that they have agreed to use. Customers will also be educated about the various insurance repair tactics that are in direct conflict with their best interests

The website 106 will preferably have functionality that allows the members to get repair shop appointments/estimates and schedule towing 86, if needed. Pre-purchase and post-repair vehicle inspections 88 may also be scheduled online, wherein the inspections certify the frame, body, and paint, etc.

Registered users may also be offered viral marketing tools through a referral system 90 that will be available to them. Users may be able to send multiple invitations via email or text message to contacts (e.g. similar to the Google Mail model). Users may be compensated (when their invitations lead to new registrations) by offering them a progressively higher deductible payout and/or other benefits, services, or discounts.

The website 106 will also offer other value-added services to third party content 92 such as online coupons (e.g. Jiffy Lube, AutoZone, Pep Boys, etc.), and obtain quotes from other service related companies (e.g. insurance, credit cards, mortgage companies, etc.) 94. The site 106 may also contain insurance repair news and education, access to legal services or a pre-paid legal network, and automotive related articles and newsletters to increase value and user retention. Users may also be able to review content on automotive related issues such as searching for a new or used car, car fax report, and car reviews. Online ads may generally be placed from section to section along the site.

Users may also be able to buy automotive parts and accessories (such as auto parts, stereos, car mats, travel mugs, etc.) through the online shopping mall 96.

Finally users may be able to initiate the repair process 98 at a participating repair shop 22 within the network 20 within the website 106.

The website may also be configured to perform (preferably automatically) or facilitate a number of functions 110. For example, once the user is registered, the website 110 may send an email confirming registration 112. Users will preferably receive detailed and specific education regarding the insurance companies' Direct Repair Programs—and how these DRP's may promote repair shortcuts and create conflicts of interest. This education will primarily focus on consumer safety and on how the proper parts and repair procedures can help preserve the original value of their vehicle. They will also be informed of their rights as the owners of their insurance policy—and how to exercise those rights with their insurance company. They will be educated on the specific repair procedures that insurance companies attempt to withhold compensation for, the potential for diminished vehicle value, and the vehicle warranty cancellation issues that can result when imitation replacement parts are used for the repair. This information may also be provided online via a page or link on the website 106.

The site 106 may also send out quotes or coupons 114 from third party companies that are requested by the consumer 102. Quotes and coupons may be sent by email or other mail delivery options.

The website 106 is also preferably configured to display the calculated deductible payout estimate 116 to the consumer 102 with use of the payout calculator 150 shown in FIG. 6.

The website may use content management software or the like to display product in the online mall 96, and automatically bill, invoice, and arrange for delivery of the product 118.

In addition, the website may facilitate all or part of the collision repair process 120 detailed in FIG. 5.

Referring now to FIG. 7, the website 106 (or other consumer interface) may also have a page or link detailing the “green” repair option 180 at sign-up. The green repair option 180 allows the consumer 102 to request and/or authorize the use of certified genuine OEM recycled parts in the repair of their vehicle (generally authorizing the repair shop 22 to use the parts whenever available). This option may cost more or less to the consumer, and the administrative entity may donate a portion of the sign-up fee to an environmentally aware charity—and provide a tax deduction certificate to the customer. In addition to the extra membership fees, the AE 30 may benefit by leveraging the consumer's awareness of the importance of recycling and protecting the environment.

This additional value channel also allows the AE 30 to add a network 46 of individual certified auto parts recyclers 48 to its repair shop network 20 and platform. The AE 30 may develop and maintain a set of quality control standards and/or inspection processes for recycled auto parts. These quality standards and/or inspection processes may be licensed to network auto parts recyclers 48. This creates more revenue opportunities for the AE 30 through licensing of the recycled parts standards, the sourcing of recycled parts for customer members 102—and by creating distribution synergies between the established network repair shops 20 and the certified parts recyclers 48. This creates more revenue opportunities for the AE 30 through the sourcing of recycled parts for members—and by creating distribution synergies between the established network repair shops 20 and certified parts recyclers 48. The AE 30 may also set 42 of a set of recycled parts standards 44 that the recyclers 48 license from the AE30, in much the same manner as the repair standards 16 to the repair shops 22. There may also be tax breaks and pollution credits available to the AE 30 as a result of integrating this option. The green repair option may also be offered completely stand alone, or with the deductible payment service for a specified annual membership fee.

FIG. 5 illustrates a method 120 for facilitating a collision repair within a network of repair facilities. All or portions of, method 120 may be performed via the website 106, or may be initiated via telephone signup with the consumer.

The process is initiated by the user notifying the AE 30 of the need for a repair via the website 106 or telephone at 122. The AE 30 site platform generates multiple participating shop referrals with maps, directions, contact information, and shop ratings with user feedback at 124.

At step 126, the AE 30 site platform site functionality stores the lead information to be accessed, updated, and tracked by the AE 30 and repair shop 22 when the lead arrives.

At step 128, the AE 30 site platform arranges the repair shop appointment for the customer. This, and many of the steps in method 120, may be performed by an automated process if applicable.

The AE 30 then arranges the towing of the vehicle if needed at step 130. The user then pays the transaction fee at step 132 (this may be done online or over phone with credit cards, or collected from repair shop 22 when the customer brings the car in for repair).

At step 124, the AE 30 site platform calculates and accesses the consumer's deductible payout amount (if any is owed), and then generates a repair record and printable deductible payment certificate (with ID record number) to be given to the repair shop 22 at step 136.

Upon customer arrival, the repair shop 22 writes an estimate as usual. The shop 22 may then log into the AE platform 100 (through dealer specific page on website 106, or separate website or other interface means) and accesses the repair record number presented by the customer at step 138. This confirms signed job acceptance by both parties—and verifies that the shop 22 will be licensing and using the repair standards 16 and technology platform 100 for the repair.

The shop 22 then enters the total amount of the approved repair estimate, gains access to the AE 30 license fee, and pays it instantly and electronically from their account or credit card at step 140.

The shop 22 and/or customer is then given access to the customer's calculated deductible payout amount—and prints a mail-in payout confirmation certificate for the customer at step 142. The customer mails in the certificate to receive their payout from the AE.

The shop 22 then collects the full deductible as usual and subtracts it from their bill to the insurance company at step 144. The 22 shop may provide their written estimate to the customer as usual.

Finally, the AE 30 may follow up with consumer by email, IVR, and/or postcard to confirm their satisfaction at step 146.

FIG. 6 illustrates a flowchart for calculating deductible payment assistance calculator in accordance with the present invention. Using this feature, users will also be able to estimate how much they may receive toward their deductible by inputting certain criteria or member data into the calculator. The percentage of consumer deductible paid (up to 100%) will vary based on factors such as the service level chosen e.g. annual fee amount paid 148, the deductible amount 152, the total estimated cost of the repair 154, how long the member has been with the service 156, and salvage value 158 (if any).

This data is entered into the deductible payout algorithm 160, and then output at 170. It is appreciated the certain levels of service signed up by the consumer may not processed by the calculator 150. For example, if the lowest level of service is selected, the consumer receives no payout—they just have access to the network 20. Or, if the highest level of service is selected, the payout may automatically be 100%, regardless of any of the factors. Intermediate levels of service may then be process through the calculator 150 for payout amount 170.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” For example, although the embodiments above are directed primarily to auto collision repair, it is appreciated that the methods and systems of the present invention may be applied to any auto repair. In addition, the methods and systems of the present invention may be applied to home, motorcycle and marine insurance in order to enhance the quality of consumer information and to increase paid user registrations. The consumer also need not have insurance to receive benefit of the methods and systems of the present invention

All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for establishing a repair network, comprising:
establishing a list of repair standards;
establishing a network of repair shops;
the repair shops agreeing to adhere to the repair standards;
providing one of the repair shops with a consumer having a vehicle needing repair; and
collecting a licensing fee from the repair shop prior to repair of said vehicle.

2. A method as recited in claim 1:
wherein said repair shop comprises an auto body repair shop; and
wherein the repair comprises auto body repair for a vehicle collision.

3. A method as recited in claim 1, further comprising:
establishing a website;
said website having data listing said repair standards and network of repair shops; and
graphically displaying said repair standards and network of repair shops for viewing by said consumer.

4. A method as recited in claim 3, wherein said consumer registers for access to said repair network through said website.

5. A method as recited in claim 4, further comprising:
collecting a fee for said consumer registration in said repair network.

6. A method as recited in claim 4, further comprising:
inputting data from a consumer from a graphic interface on said website.

7. A method as recited in claim 6, further comprising:
compiling said consumer data into a consumer list.

8. A method as recited in claim 6, further comprising:
generating qualified sales leads from said consumer data.

9. A method as recited in claim 6, further comprising:
calculating a payout to said consumer based on said data; and
paying said payout to said consumer upon repair of said vehicle within said network using said repair standards.

10. A method as recited in claim 9, wherein said payout is a function of the consumer's membership fee.

11. A method as recited in claim 10, wherein the payout is a function of a cost of the auto repair.

12. A method as recited in claim 10, wherein the payout is a function of an insurance deductible of the consumer.

13. A method as recited in claim 1, further comprising:
establishing a network of auto recyclers having certified OEM parts;
wherein said network of repair shop agrees to use said OEM parts from one or more of said auto recyclers in repairing said vehicle.

14. A method for establishing a repair network, comprising:
establishing list of repair standards;
establishing a network of repair shops;
said repair shops agreeing to adhere to the repair standards;
inputting data from a consumer, said data relating to a vehicle repair;
calculating a payout to said consumer based on said data; and
paying said payout to said consumer upon repair of said vehicle within said network using said repair standards.

15. A method as recited in claim 14, further comprising:
collecting a licensing fee from said repair shop prior to repair of said vehicle.

16. A method as recited in claim 14:
wherein said repair shop comprises an auto body repair shop;
wherein the repair comprises auto body repair for a vehicle collision; and
wherein said payout corresponds to an insurance deductible related to said vehicle collision.

17. A method as recited in claim 14, further comprising:
establishing a website;
said website having data listing said repair standards and network of repair shops;
and graphically displaying said repair standards and network of repair shops for viewing by said consumer.

18. A method as recited in claim 17, wherein said consumer may register for access to said repair network through said website.

19. A method as recited in claim 18, further comprising:
collecting a fee for said consumer registration in said repair network.

20. A method as recited in claim 18, further comprising:
compiling said consumer said data into a consumer list.

21. A method as recited in claim 17, further comprising:
generating qualified sales leads from said consumer data.

22. A method as recited in claim 16, wherein said payout is a function of the consumer's membership fee.

23. A method as recited in claim 16, wherein the payout is a function of a cost of the auto repair.

24. A method for providing repair of a vehicle, comprising:
establishing an administrative entity;
establishing list of repair standards;
establishing a network of repair shops;
said repair shops agreeing to adhere to said repair standards;
providing one of said repair shops with a consumer having a vehicle needing repair;
said consumer being one of a network of consumers registered with said administrative entity;
providing a platform for the network of repair shops and network of consumers to interface with said entity; and
collecting a licensing fee from said repair shop for said platform;
said licensing fee resulting from a transactional license between the administrative entity and the repair shop prior to repair said vehicle.

25. A method as recited in claim 24, wherein the licensing fee and transactional license are on a per-repair basis.

26. A method as recited in claim 24:
wherein said platform comprises a website;
said website having data listing said repair standards and network of repair shops; and
further comprising graphically displaying said repair standards and network of repair shops for viewing by said consumer.

27. A method as recited in claim 24, further comprising:
calculating a payout to said consumer based on said data; and
paying said payout to said consumer upon repair of said vehicle within said network using said repair standards.

28. A method as recited in claim 24, further comprising:
establishing a network of auto recyclers having certified OEM parts;
wherein said network of repair shop agrees to use said OEM parts from one or more of said auto recyclers in repairing said vehicle.

29. A method as recited in claim 24, wherein the website is configured to display a list of repair shops based on location with respect to the consumer.

30. A method as recited in claim 24, wherein the website is configured to automatically set a repair appointment for the consumer at a selected repair shop.
